(19) United States
(12) Patent Application Publication
(10) Pub. No.: US 2007/0289800 A1
(43) Pub. Date: Dec. 20, 2007

(54) Vehicle seat detecting system

(75) Inventors: Hiroshi Aoki, Tokyo (JP); Masato Yokoo, Tokyo (JP); Yuu Hakomori, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/812,492

(22) Filed: Jun. 19, 2007

(30) Foreign Application Priority Data
Jun. 20, 2006 (JP) 2006-170124

(51) Int. Cl. B60K 28/00; B60L 1/00

(52) U.S. Cl. 180/273; 180/271; 307/10.1

(57) ABSTRACT

A system is provided which is effective for precisely detecting the positional conditions of a vehicle seat. A vehicle seat detecting system which is installed in a vehicle employs a system for detecting a three-dimensional surface profile of a vehicle seat from a single view point by a camera to conduct a process for deriving information about a seat back shoulder region among respective regions of the vehicle seat and then to detect the positional conditions of the vehicle seat based on the derived information about the seat back shoulder region.

### BACKGROUND

The present invention relates to an object detecting technology which is adapted to a vehicle and, more particularly, to a technology for developing a detecting system of detecting information about a vehicle seat.

Conventionally, there are known various technologies for detecting information about an object occupying a vehicle seat by using an imaging device such as a camera. For example, JP-A-2003-294855 discloses a configuration of an occupant detecting apparatus in which a camera arranged in front of a vehicle occupant is used to detect the position of the vehicle occupant sitting in a vehicle seat.

There is a demand for technology for detecting the positional conditions of a vehicle seat using an occupant detecting apparatus as disclosed in the aforementioned patent document. By detecting the positional conditions of the vehicle seat, it is possible to obtain information such as the anteroposterior position of the vehicle seat, the inclination angle of the seat back, and the height of the seat cushion and it is also possible to determine the state of a vehicle occupant who closely fits the vehicle seat, However, since the front surface of the vehicle seat is covered by the vehicle occupant sitting in the seat, it is difficult to precisely detect the whole vehicle seat by using an imaging device such as a camera.

Accordingly, there is a need for technology, relating to a detecting system to be installed in a vehicle, which is effective for precisely detecting the positional conditions of a vehicle seat.

### SUMMARY

According to one embodiment, a vehicle seat detecting system, including an imaging device for detecting a three-dimensional surface profile of the vehicle seat from a single view point, a controller including an image processor for digitizing the three-dimensional surface profile detected by the imaging device into a numerical coordinate system and a computational processor for conducting a process for deriving information about a seat back shoulder region among respective regions of the vehicle seat based on the numerical coordinate system of the three-dimensional surface profile digitized by the image processor.

According to another embodiment, a vehicle seat detecting system, includes a storage device for storing plural kinds of positional information of the seat back shoulder region, wherein the image processor derives information, mostly matching the information detected by the imaging device, as the information about the seat back shoulder region from the plural kinds of positional information previously stored in the storage device.

According to still another embodiment, the image processor scans a plurality of points along a vertical direction on the back side of a seat back side edge by scanning beams from the rear to the front of the vehicle and derives information about the seat back shoulder region based on the information about the plurality of points of the seat back side edge detected by the scanning.

According to yet another embodiment, the computational processor of the vehicle seat detecting system conducts a process for determining the positional condition of the vehicle seat based on the derived information about the seat back shoulder region

According to another embodiment, an operation device controlling system includes a vehicle seat detecting system, an operation device which is actuated based on the positional condition of the vehicle seat determined by the processor of the vehicle seat detecting system and a controller for controlling the actuation of the operation device.

According to still another embodiment, a vehicle includes an engine/running system, an electrical system, an actuation control device for conducting the actuation control of the engine/running system and the electrical system and a vehicle seat detecting system for detecting positional condition of a vehicle seat.

According to another embodiment, a vehicle seat detecting system, includes an imaging device for detecting a three-dimensional surface profile of the vehicle seat from a single view point, an image processor for digitizing the three-dimensional surface profile detected by the imaging device into a numerical coordinate system and a computational processor for conducting a process for deriving information about a seat back shoulder region among respective regions of the vehicle seat based on the numerical coordinate system of the three-dimensional surface profile digitized by the image processor.

According to yet another embodiment, a seat detecting method includes the steps of detecting a three-dimensional surface profile of the vehicle seat from a single view point, digitizing the detected three-dimensional surface profile into a numerical coordinate system; deriving information about a seat back shoulder region among respective regions of the vehicle seat based on the numerical coordinate system, and storing the information about the seat back shoulder region.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description, appended claims, and the accompanying exemplary embodiments shown in the drawings, which are briefly described below.

FIG. 1 is an illustration showing a system structure of a vehicle seat detecting system 100, which is installed in a vehicle, according to one embodiment.

FIG. 2 is a perspective view showing a vehicle cabin taken from a camera 112 side, according to one embodiment.

FIG. 3 is a flow chart of a vehicle seat detection process for detecting information about a driver's seat in the vehicle seat detecting system 100, according to one embodiment.

FIG. 4 is an illustration showing an aspect of pixel segmentation, according to one embodiment.

FIG. 5 is an illustration showing a segmentation-processed image C1, according to one embodiment.

FIG. 6 is an illustration showing some examples of a plurality of configurations of a seat back shoulder region which are previously stored in a storing section 152 of a storage device 150, according to one embodiment.

FIG. 7 is an illustration showing the inclination angle θ of the seat back 14, the center position A of the seat back shoulder region 14a, and the like, according to one embodiment.

FIG. 8 is an illustration showing a case that a back side of a seat back side edge 14b is scanned at a plurality of points along the vertical direction by a plurality of scanning beams M from the rear to the front of the vehicle according to the segmentation-processed image C1 obtained at step S103 for the vehicle seat detecting process, according to one embodiment.

FIG. 9 is an illustration showing, taken from above the driver's seat 12, a scanning range 15 using the scanning beams M shown in FIG. 8, according to one embodiment.

### DETAILED DESCRIPTION

Embodiments of the present invention will be described below with reference to the accompanying drawings. It should be understood that the following description is intended to describe exemplary embodiments of the invention, and not to limit the invention.

According to one embodiment, the present invention is configured to detect the positional conditions of a vehicle seat. Though the present invention is typically adapted to a detecting system in an automobile for detecting information about a vehicle seat, the present invention can be also adapted to a technology for developing a detecting system in a vehicle other than the automobile for detecting information about a vehicle seat.

According to one embodiment, the vehicle seat detecting system comprises at least an imaging device, an image processor, and a computational processor.

According to one embodiment, the imaging device detects a three-dimensional surface profile of a vehicle seat from a single view point. This structure is achieved by installing a 3D camera, capable of detecting a three-dimensional surface profile, inside a vehicle cabin. The single view point may correspond to an arrangement where a single camera is mounted at a single place. As the camera capable of taking images from a single view point, a 3-D type monocular C-MOS camera or a 3-D type pantoscopic stereo camera may be employed. Since all that is required is the installation of a single camera which is focused on the vehicle seat with regard to the single view point, the present embodiment does not preclude the installation of another camera or another view point for another purpose. Since the object to be detected by the imaging device includes at least the vehicle seat, a vehicle occupant or an article occupying the vehicle seat can be also detected together with the detection of the vehicle seat.

According to one embodiment, the image processor digitizes the three-dimensional surface profile detected by the imaging device into a numerical coordinate system. The three-dimensional surface profile of the vehicle seat from the single view point detected by the imaging device is digitized into a numerical coordinate system.

According to one embodiment, the computational processor derives information about a seat back shoulder region among respective regions of the vehicle seat based on the numerical coordinate system of the three-dimensional surface profile digitized by the image processor. The seat back shoulder region may be defined as a region about a shoulder of the seat back, i.e. including a portion extending from a side edge to an upper edge and peripheral portions of the seat back. The information about the seat back shoulder region may include information about the position and the inclination angle of the seat back shoulder region. Among respective regions of the vehicle seat, the seat back is closely related to the positional conditions of the driver's seat. Consequently, the position and the inclination angle of the seat back shoulder region can be used as reference for obtaining the position and the inclination angle of the whole seat back. By using the seat back shoulder region as reference, the position of the seat back, the anteroposterior position of the seat, and the height of the seat cushion can be obtained. In addition, among respective regions of the seat back, especially the seat back shoulder region is allowed to be detected easily by the three-dimensional surface profile without being disturbed by a vehicle occupant. When at least information about (position, inclination angle etc.) the seat back shoulder region as a region of the vehicle seat is derived, the positional conditions of the vehicle seat such as the inclination angle of the seat back, the anteroposterior position of the seat, and the height of the seat cushion of the vehicle seat can be precisely determined even though the whole vehicle seat is not detected.

According to the aforementioned arrangement of the vehicle seat detecting system as, the positional conditions of the vehicle seat can be precisely detected by deriving information about the seat back shoulder region.

According to another embodiment, the vehicle seat detecting system further comprises a storage device. The storage device stores plural kinds of positional information of the seat back shoulder region. The plural kinds of positional information of the seat back shoulder region may include information about configurations of the seat back shoulder region, each representing a different position or inclination angle of the seat back shoulder region. The computational processor is structured to derive information, mostly matching the information detected by the imaging device, as the information about the seat back shoulder region from the plural kinds of positional information previously stored in the storage device.

The positional conditions of the vehicle seat can be precisely detected by deriving information about the seat back shoulder region using the previously stored positional information of the seat back shoulder region. By increasing the number of positional information of the seat back shoulder region previously stored in the storage device, the detection precision in detecting the positional conditions of the vehicle seat can be increased.

According to one embodiment, in the numerical coordinate system of the three-dimensional surface profile digitized by the image processor, the image processor scans a plurality of points along a vertical direction on the back side of a seat back side edge by scanning beams from the rear to the front of the vehicle and derives information about the seat back shoulder region based on the information about the plurality of points of the seat back side edge detected by the scanning. The seat back side edge may be defined as a region along a side edge among respective regions of the seat back. In case of scanning the back side of the seat back side edge in the vertical direction, only the back of the seat back is continuously detected without detecting the head rest. In this case, it can be determined that the uppermost detected point which is positioned at the top among the detected points corresponds to a position of the seat back shoulder region. The inclination angle of the back of the seat back corresponds to the inclination angle of the seat back shoulder region. Accordingly, the positional conditions of the vehicle seat can be precisely detected by deriving information about the seat back shoulder region using the scanning beams from the rear to the front of the vehicle.

According to another embodiment, in the vehicle seat detecting system the computational processor determines the positional conditions of the vehicle seat based on the derived information about the seat back shoulder region. By the processor, the positional conditions of the vehicle seat are determined. The positional conditions of the vehicle seat widely include the position and the attitude of the vehicle seat (a driver's seat, a front passenger seat, a rear seat) and generally include the height of the seat cushion, the inclination angle of the seat back, and the anteroposterior position of the seat of the vehicle seat. In the computational processor, the process of deriving information about the seat back shoulder region, the process of determining the positional conditions of the vehicle seat may be conducted by a single processing unit or may be conducted by separate processing units. Accordingly, a system capable of deriving information about the seat back shoulder region and precisely determining the positional conditions of the vehicle seat from the derived information can be constructed.

According to another embodiment, an operation device controlling system includes at least a vehicle seat detecting system, an operation device, and an actuation controller.

According to one embodiment, the operation device of this invention is actuated based on the positional conditions of the vehicle seat determined by the processor of the vehicle seat detecting system and is controlled its actuation by the actuation controller. As the operation device, an arrangement for informing of the information about the vehicle seat itself, an arrangement for producing an alarm indicating that the positional condition of the vehicle seat is out of the standard range according to the detected information, an arrangement for determining the position, the body size, and movement of the vehicle occupant from the detected information and then changing the mode of occupant restraint by an airbag and/or a seat belt according to the information of the determination may be employed. Accordingly, the actuation of the operation device can be controlled in a suitable mode according to the results of the determination of the vehicle seat detecting system, thereby enabling detailed control for the operation device.

According to another embodiment, a vehicle includes at least an engine/running system; an electrical system; an actuation control device; and a vehicle seat detecting system. The engine/running system is a system involving an engine and a running mechanism of the vehicle. The electrical system is a system involving electrical parts used in the vehicle. The actuation control device is a device having a function of conducting the actuation control of the engine/running system and the electrical system. The vehicle seat detecting system detects positional conditions of a vehicle seat. Accordingly, there is provided a vehicle mounted with a vehicle seat detecting system capable of precisely detecting the positional conditions of the vehicle seat.

As described in the above, according to one embodiment of the present invention, information about a seat back shoulder region among respective regions of a vehicle seat is derived by using an arrangement for detecting three-dimensional surface profile of the vehicle seat from a single view point, thereby enabling precise detection of the positional conditions of the vehicle seat.

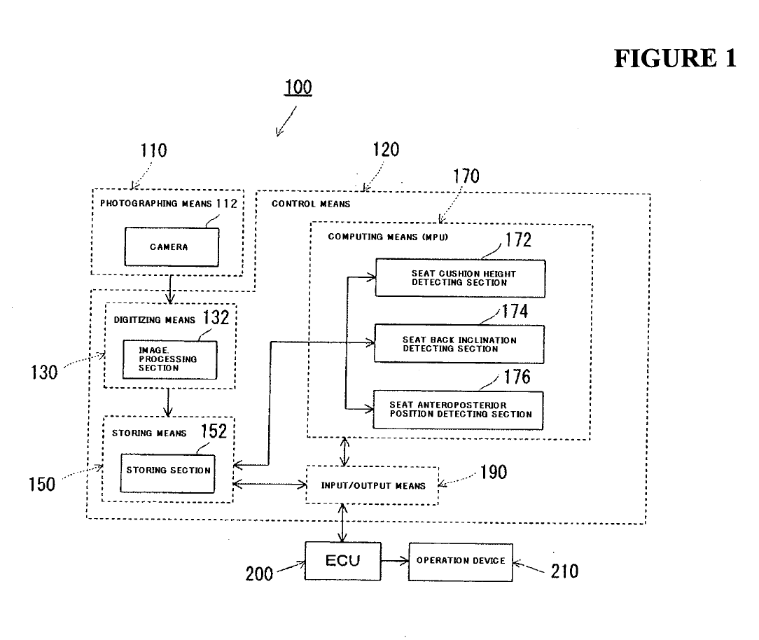

Hereinafter, description will be made as regard to embodiments of the present invention with reference to drawings. First, a vehicle seat detecting system 100 as an embodiment of the present invention will be described with reference to FIG. 1 through FIG. 7.

The structure of the vehicle seat detecting system 100, which is installed in a vehicle, of this embodiment is shown in FIG. 1. The vehicle seat detecting system 100 of this embodiment may be installed in an automobile for detecting at least information about a vehicle seat. As shown in FIG. 1, the vehicle seat detecting system 100 mainly comprises an imaging device 110 and a controller 120.

Further, the vehicle seat detecting system 100 cooperates together with an ECU 200 as an actuation control device for the vehicle and an operation device 210. The vehicle comprises, but not shown, an engine/running system involving an engine and a running mechanism of the vehicle, an electrical system involving electrical parts used in the vehicle, and an actuation control device (ECU 200) for conducting the actuation control of the engine/running system and the electrical system.

The imaging device or photographing mechanism 110 may include a camera 112 as the photographing device and a data transfer circuit. The camera 112 is a 3-D (three-dimensional) camera (sometimes called “monitor”) of a C-MOS or CCD (charge-coupled device) type in which light sensors are arranged into an array (lattice) arrangement. The camera 112 comprises an optical lens and a distance measuring image chip such as a CCD (charge-coupled device) or C-MOS chip, but not especially shown. Light incident on the distance measuring image chip through the optical lens is focused on a focusing area of the distance measuring image chip 116. With respect to the camera 112, a light source for emitting light to an object may be suitably arranged. By the camera 112 having the aforementioned structure, information about distance relative to the object is measured a plurality of times to detect a three-dimensional surface profile which is used to identify the presence or absence, the size, the position, the attitude, and the movement of the object. Therefore, the photographing mechanism 110 may be a device for detecting the three-dimensional surface profile of a vehicle seat.

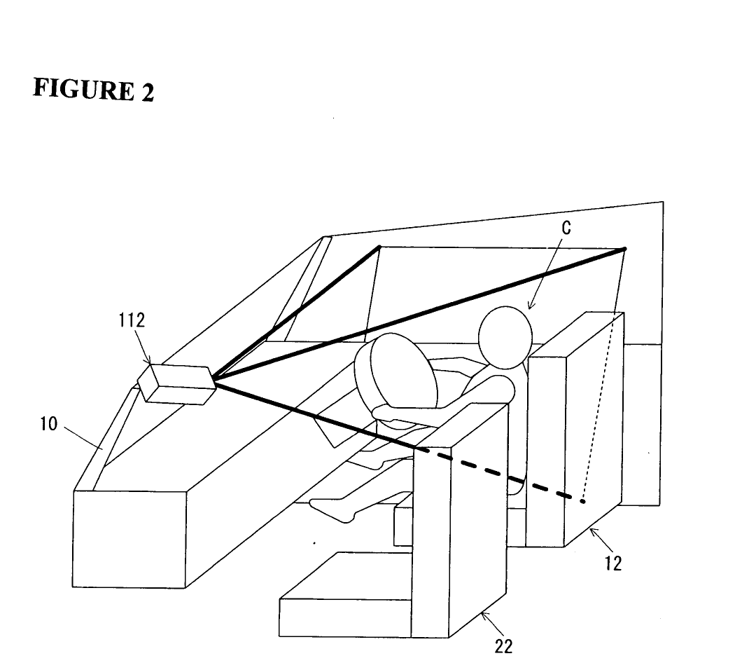

The camera 112 having the aforementioned structure is mounted, in a embedding manner, on an instrument panel in a frontward portion of the vehicle, an area around an A-pillar, or an area around a windshield of the automobile in such a manner as to face one or a plurality of vehicle seats. As an installation example of the camera 112, a perspective view of a vehicle cabin taken from a side of the camera 112 according to one embodiment is shown in FIG. 2. As shown in FIG. 2, the camera 112 is disposed at an upper portion of an A-pillar 10 on a side of a front passenger seat 22 to be directed in a direction capable of photographing an occupant C on a driver's seat 12 to take an image with the occupant C positioned on the center thereof. The camera 112 is set to start its photographing operation, for example, when an ignition key is turned ON or when a seat sensor (not shown) installed in the driver seat detects a vehicle occupant sitting in the driver seat.

The controller 120 of this embodiment further comprises at least a processor (e.g., an image processor), a storage device 150, a computing/computational processor (MPU) 170, an input/output device 190, and peripheral devices (not shown).

The processor 130 comprises an image processing section 132 which also conducts camera control for controlling the camera to obtain good quality images and image processing control for processing images taken by the camera 112 to be used for analysis. Specifically, as for the control of the camera, the adjustment of the frame rate, the shutter speed, and the sensitivity, and the accuracy correction are conducted to control the dynamic range, the brightness, and the white balance. As for the image processing control, the spin compensation for image, the correction for distortion of the lens, the filtering operation, and the difference operation as image preprocessing operations are conducted and the configuration determination and the trucking as image recognition processing operations are conducted. The processor 130 is also configured to digitize a three-dimensional surface profile detected by the camera 112 into a numerical coordinate system. The image processor 130 digitizes the three-dimensional surface profile detected by the imaging device into a numerical coordinate system. Information obtained by the image processor 130 is stored in a storing section 152 of the storage device 150 once and is read out from the storing section 152 each time for the computing process by the computational processor 170.

The storage device 150 comprises the storing section 152 and stores (recording) data for correction, buffer frame memory for preprocessing, defined data for recognition computing, reference patterns, the image processing results of the image processing section 132 of the image processor 130, and the computed results of the computing processor 170 as well as an operation control software. The storage device 150 of this embodiment previously stores a plurality of configurations of a shoulder region of a seat back, each representing a different inclination angle of the seat back shifted from the next one by a predetermined angle, that is, positional information of the seat back shoulder region and angular information of the seat back in a plurality of positional conditions of the shoulder region of the seat back, as will be described in detail. The stored information is used in “pattern matching” as will be described later. The storage device 150 (including the storing section 152) may correspond to a storage device for storing plural kinds of positional information of the seat back shoulder region.

The computational processor 170, according to one embodiment, is configured to extract information about the vehicle seat (the driver's seat 12 in FIG. 2) as an object based on the information obtained by the process of the image processing section 132 and comprises at least a seat cushion height detecting section 172, a seat back inclination detecting section 174, and a seat anteroposterior position detecting section 176. The seat cushion height detecting section 172 has a function of detecting the height of the seat cushion of the driver's seat 12. The seat back inclination detecting section 174 has a function of detecting the inclination of the seat back of the driver's seat 12. The seat anteroposterior position detecting section 176 has a function of detecting information about the anteroposterior position of the driver's seat 12. The computational processor 170 has a function of deriving information about the seat back shoulder region among respective regions of the vehicle seat and a function of determining the positional conditions of the vehicle seat.

According to one embodiment, the input/output devices 190 inputs information about the vehicle, information about traffic conditions around the vehicle, information about weather condition and about time zone, and the like to the ECU 200 for conducting controls of the whole vehicle and outputs recognition results. As the information about the vehicle, there are, for example, the state (open or closed) of a vehicle door, the wearing state of the seat belt, the operation of brakes, the vehicle speed, and the steering angle. In this embodiment, based on the information outputted from the input/output devices 190, the ECU 200 outputs actuation control signals to the operation device 210 as an object to be operated. The ECU 200 for controlling the actuation of the operation device 210 may correspond to an actuation controller. As concrete examples of the operation device 210, there are an occupant restraining device for restraining an occupant by an airbag and/or a seat belt and a device for outputting warning or alarm signals (display, sound and so on), and the like.

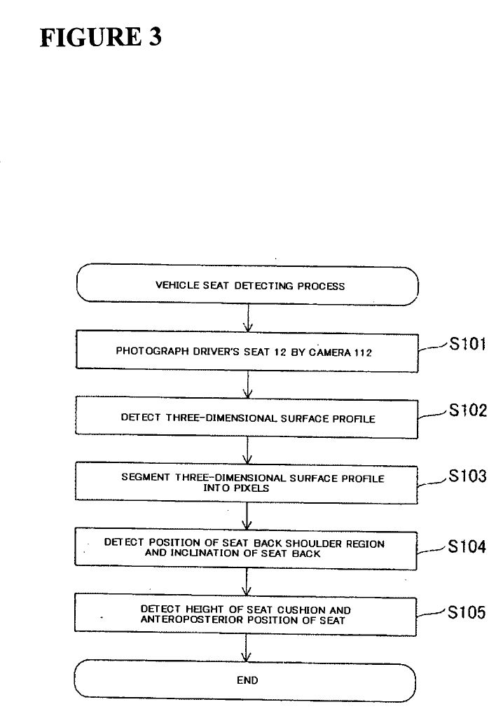

Hereinafter, the action of the vehicle seat detecting system 100 having the aforementioned structure will be described with reference to FIG. 3 through FIG. 7 in addition to FIG. 1 and FIG. 2.

FIG. 3 is a flow chart of a vehicle seat detecting process for detecting information of a driver's seat (vehicle seat) in the vehicle seat detecting system 100 according to one embodiment. In this embodiment, the vehicle seat detecting process is carried out by the imaging device 110 (the camera 112) and the controller 120 as shown in FIG. 1.

According to a vehicle seat detecting process, image is taken by the camera 112 such that a driver's seat (the driver's seat 12 in FIG. 2) and a vehicle occupant (the vehicle occupant C in FIG. 2) are positioned at the center of the image. At step S102 in FIG. 3, at least the three-dimensional surface profile of the driver's seat 12 as the object is detected based on the image obtained by the camera 112. The imaging device 110 including the camera 112 detects a three-dimensional surface profile of the driver's seat as a vehicle seat from a single view point. Since the object to be detected by the camera 112 of this embodiment includes at least the vehicle seat, a vehicle occupant or an article occupying the vehicle seat can be also detected together with the detection of the vehicle seat. The single view point corresponds to a style where the number of installation places of the camera is one, that is, a single camera is mounted at a single place. As the camera 112 capable of taking images from a single view point, a 3-D type monocular C-MOS camera or a 3-D type pantoscopic stereo camera may be employed.

According to one embodiment, a 3D-type camera capable of detecting 3D (three-dimensional) images using “time-of-flight (TOF) technique” is used as the camera 112. The time-of-flight technique is a method in which distance from an object is measured according to the time delay between reflection of light on the object and detection of the light by the camera and is known as a technique capable of detecting a three-dimensional surface profile of the object by measuring distances from a plurality of points on the three-dimensional surface profile of the object. As the technique, a time-of-flight style in which ultrasonic wave or light is used to measure time between emission and return thereof and a phase-detection style in which light having amplitude modulated into sinusoidal waveform is used to detect phase lag according to the distance from an object may be used.

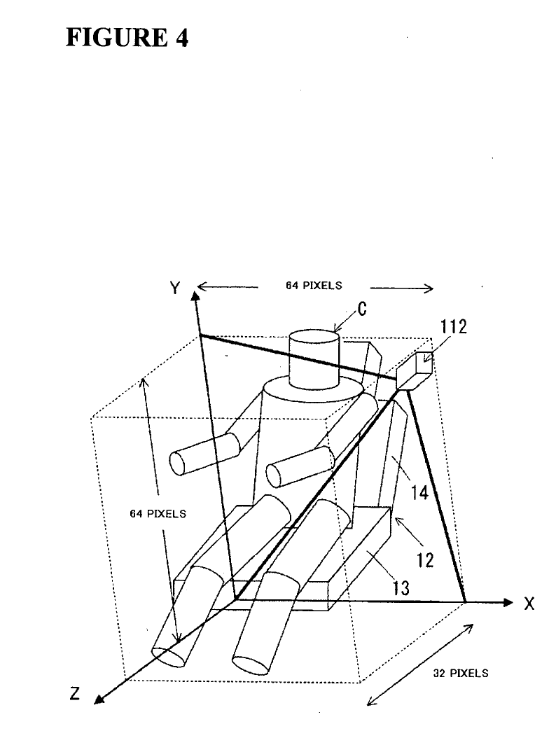

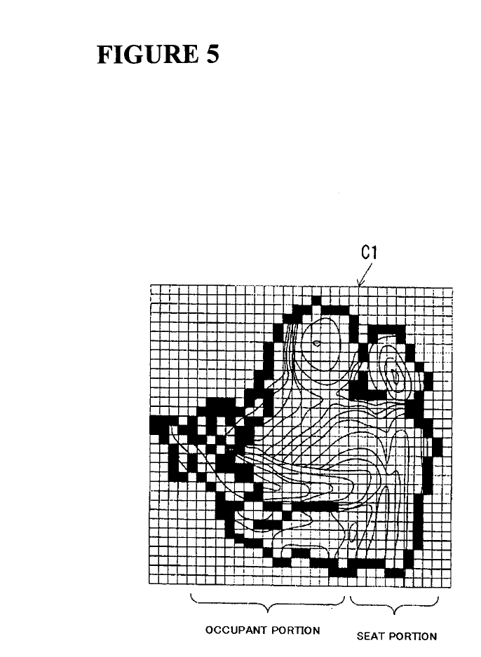

At step S103 in FIG. 3, a segmentation process is conducted to segment a dot image of the three-dimensional surface profile obtained at step S102 into a large number of pixels. In the segmentation process, the dot image of the three-dimensional surface profile is segmented into three-dimensional lattices (X64)×(Y64)×(Z32). An aspect of pixel segmentation in this embodiment is shown in FIG. 4. As shown in FIG. 4, the center of a plane to be photographed by the camera is set as an origin, an X axis is set as lateral, a Y axis is set as vertical, and a Z axis is set as anteroposterior. With respect to the dot image of the three-dimensional surface profile, a certain range of the X axis and a certain range of the Y axis are segmented into respective 64 pixels, and a certain range of the Z axis is segmented into 32 pixels. It should be noted that, if a plurality of dots are superposed on the same pixel, an average is employed. According to the process, a segmentation-processed image C1 of the three-dimensional surface profile as shown in FIG. 5 is obtained for example. FIG. 5 is an illustration showing a segmentation-processed image C1 of this embodiment. The segmentation-processed image C1 corresponds to a perspective view of the vehicle occupant C taken from the camera 112 and shows a coordinate system about the camera 112. In this manner, the three-dimensional surface profile detected by the camera 112 is digitized into a numerical coordinate system, thereby obtaining the segmentation-processed image C1.

At step S104 in FIG. 3, a process for detecting the position and the inclination of the seat back shoulder region of the seat back (the seat back 14 shown in FIG. 4) of the driver's seat 12 is conducted using the segmentation-processed image C1 obtained at step S103. The seat back shoulder region corresponds to a region about a shoulder of the seat back, i.e. including a portion extending from a side edge to an upper edge and peripheral portions thereof. This detection process is carried out by the seat back inclination detecting section 174 shown in FIG. 1. As for the information about the position and the inclination of the seat back shoulder region of the seat back, it does not necessarily require both information because one of the information can be estimated from fragmentary information or predetermined values can be used instead of detecting one of the information.

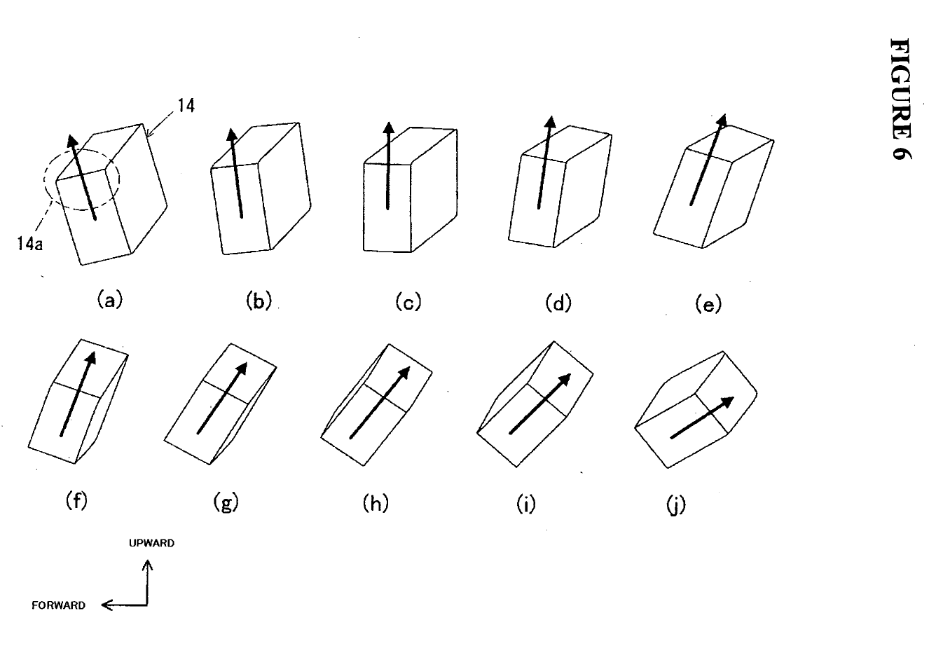

Specifically, an image of the seat back shoulder region 14a of the driver's seat 12 actually detected by the camera 112 is compared to a plurality of configurations of the seat back shoulder region previously stored in the storing section 152 of the storage device 150 so as to retrieve a configuration which is coincident with or the nearest to the actually detected configuration, i.e. “pattern matching” is conducted. FIG. 6 shows some examples of the plurality of configurations of the seat back shoulder region which are previously stored in the storing section 152 of the storage device 150 of this embodiment. In FIG. 6, ten examples (a) through (j) of the configuration of the seat back shoulder region 14a of the driver's seat 12 are illustrated in which each configuration represents a different inclination angle of the seat back 14 shifted from the next one by a predetermined angle. Each arrow in FIG. 6 indicates the direction of the seat back 14 (the seat back shoulder region 14a). A configuration (c) in FIG. 6 indicates a state that the seat back shoulder region 14a stands almost vertically. Configurations (a) and (b) indicate states that the seat back shoulder region 14a is inclined forward from the configuration (c). Configurations (d) through (j) indicate state that the seat back shoulder region 14a is inclined backward from the configuration (c).

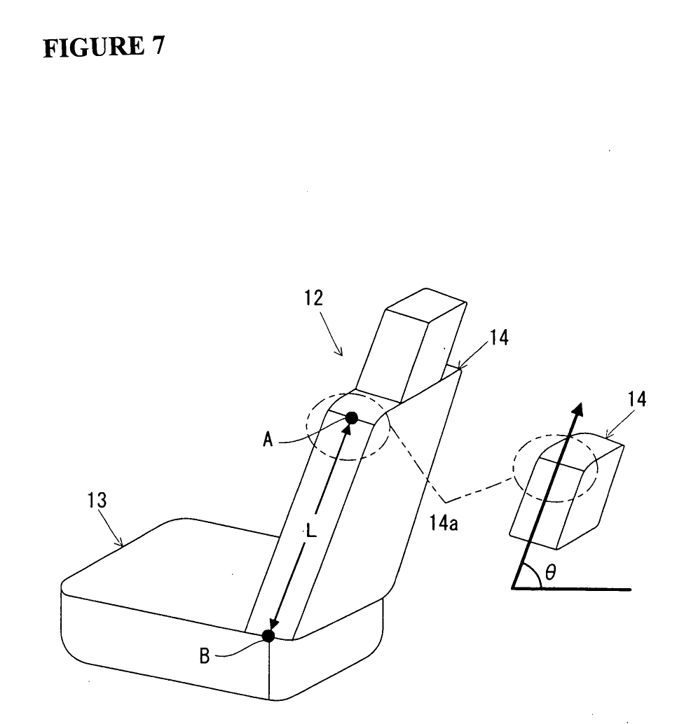

Among the plurality of configurations previously stored in the storing section 152 of the storage device 150, one configuration of which degree of matching (matching percentage) with the image of the seat back shoulder region 14a actually detected is highest is selected. From the inclination angle and the position of the selected configuration, the inclination angle and the position of the seat back shoulder region 14a are derived. An inclination angle θ of the seat back 14 and a center position A of the seat back shoulder region 14a of this embodiment are shown in FIG. 7. The inclination angle θ of the seat back 14 coincides with the inclination angle of the seat back shoulder region 14a.

The disclosed process is a process of deriving information, mostly matching the information detected by the imaging device, as the information about the seat back shoulder region from the plural kinds of positional information previously stored in the storage device.

According to one embodiment, the movements of the driver's seat 12 include the anteroposterior sliding movement and the adjustment of the inclination angle of the seat back are adjustable. Even with combination of these two kinds of movement, the movement range of the seat back shoulder region 14a is limited. The nearer to a vehicle top (ceiling panel) the seat back shoulder region 14a is, the more vertical the seat back 14 stands. On the other hand, the nearer to a vehicle bottom (floor) the seat back shoulder region 14a is, the more horizontal the seat back 14 lies. That is, there is a limitation as mentioned above. Taking such information into account, efficient pattern matching is achieved.

At step S105 in FIG. 3, a process for detecting the height (seating level) of the seat cushion 13 and the anteroposterior position of the driver's seat 12 is conducted. The detection process is carried out by the seat cushion height detecting section 172 and the seat anteroposterior position detecting section 176 shown in FIG. 1.

For this process, the length L of the seat back 14 as shown in FIG. 7 is previously stored in the storing section 152 of the storage device 150. As shown in FIG. 7, the length L is a distance between the center position A of the seat back shoulder region 14a and a reference position B of the seat cushion 13. Therefore, the height (seating level) of the seat cushion 13 and the anteroposterior position of the seat can be calculated from the angle θ and the center position A of the seat back 14 actually derived at step S104. That is, the position downwardly apart from the center position A at the angle θ by the distance L is the top (level) of the seat cushion 13 and the rearmost end (the rearmost portion) of the seat in the anteroposterior direction.

The aforementioned process determinants the positional condition of the vehicle seat based on the derived information about the seat back shoulder region.

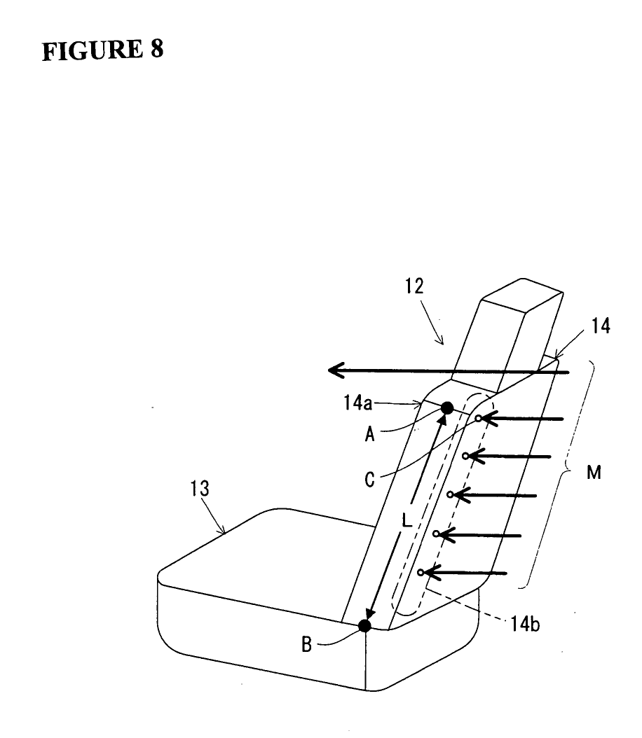

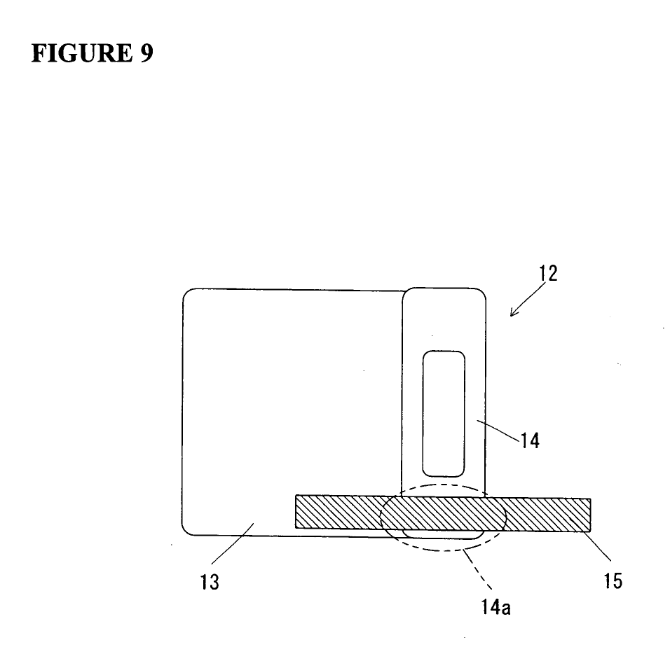

Also in this embodiment, the inclination angle of the seat back 14, the height (seating level) of the seat cushion 13, and the anteroposterior position of the seat can be derived in a method other than the aforementioned “pattern matching”. Hereinafter, another deriving method for deriving information about the vehicle seat will be described with reference to FIG. 8 and FIG. 9. FIG. 8 shows a case that a back side of a seat back side edge 14b is scanned at a plurality of points along the vertical direction by a plurality of scanning beams M from the rear to the front of the vehicle according to the segmentation-processed image C1 obtained at step S103 for the vehicle seat detecting process of this embodiment. FIG. 9 is an illustration, taken from above the driver's seat 12, showing a scanning range 15 using the scanning beams M.

As shown in FIG. 8 and FIG. 9, the back side of the seat back side edge 14b is scanned at a plurality of points along the vertical direction by a plurality of scanning beams M from behind the driver's seat 12 toward the front of the driver's seat 12 so as to detect one point at which the configuration is first detected. In the example shown in FIG. 8, there are five points detected by the scanning beams M. The seat back side edge 14b is defined as a portion along the edge of the side of the seat back 14. In case of scanning the back side of the seat back side edge 14b in the vertical direction, only the back of the seat back 14 is continuously detected without detecting the head rest. In this case, it can be determined that the uppermost detected point C which is positioned at the top among the detected points corresponds to a position on the back of the seat back shoulder region 14a.

That is, since the scanning range 15 shown in FIG. 9 is a range where the scanning beams are interfered by the seat back 14 and are not interfered by the head rest, the upper most detected point C detected in the scanning range 15 corresponds to the seat back shoulder region 14a as the upper end of the seat back 14. When the thickness d of the seat back 14 is previously stored, the position apart from the detected point C by (d/2) in a direction toward the front of the vehicle is defined as the center position A of the seat back shoulder region 14a. In addition, the inclination angle θ of the seat back 14 (the seat back shoulder region 14a) can be derived by obtaining the angle of a line connecting the plurality of detected points.

The aforementioned scanning process scans a plurality of points along a vertical direction on the back side of a seat back side edge by scanning beams from the rear to the front of the vehicle and deriving information about the seat back shoulder region, based on the information about the plurality of points of the seat back side edge detected by the scanning.

Further, the height (seating level) of the seat cushion 13 and the anteroposterior position of the seat can be detected in the same manner as that at step S105 of the aforementioned “pattern matching.”

Then, based on the detected information about the inclination angle of the seat back 14, the height (seating level) of the seat cushion 13, and the anteroposterior position of the seat detected by the vehicle seat detecting system 100 having the aforementioned structure, the operation device 210 is actuated. Specifically, an arrangement for informing of the information about the vehicle seat itself, an arrangement for producing an alarm indicating that the positional condition of the vehicle seat is out of the standard range according to the detected information, an arrangement for determining the position, the body size, and movement of the vehicle occupant from the detected information and then changing the mode of occupant restraint by an airbag and/or a seat belt according to the information of the determination may be employed.

As mentioned above, the vehicle seat detecting system 100, according to one embodiment, is structured to determine the positional conditions of the driver seat 12 by detecting the position and the inclination angle of the seat back shoulder region 14a among respective regions of the driver's seat 12. Since a front surface of a vehicle seat is covered by a vehicle occupant sitting in the seat, it is difficult to precisely detect the whole vehicle seat using an imaging device such as a camera. Then, the inventors focused attention on the seat back shoulder region 14a which is closely related to the positional conditions of the whole driver's seat 12. Consequently in this embodiment, the vehicle seat detecting system is structured to detect the position and the inclination angle of the seat back shoulder region 14a in order to detect the positional conditions of the driver's seat 12. That is, the position and the inclination angle of the seat back shoulder region 14a can be used as reference for obtaining the position and the inclination angle of the whole seat back 14. By using the seat back shoulder region 14a as reference, the position of the seat back, the anteroposterior position of the seat, and the height of the seat cushion can be obtained. In addition, among respective regions of the seat back 14, especially the seat back shoulder region 14a is allowed to be detected easily by the camera 112 without being disturbed by the vehicle occupant in view of the position. When at least information about (position, inclination angle etc.) the seat back shoulder region 14a as a region of the driver's seat 12 is derived, the positional conditions of the vehicle seat such as the inclination angle of the seat back, the anteroposterior position of the seat, and the height of the seat cushion of the driver's seat 12 can be precisely determined even though the whole driver's seat 12 is not detected.

The present invention is not limited to the aforementioned embodiment and various applications and modifications may be made. For example, the following respective embodiments based on the aforementioned embodiment may be carried out. According to one embodiment, the processor may have at least a function of deriving information about a seat back shoulder region among respective regions of a vehicle seat.

According to another embodiment, the object to be detected by the camera 112 may be a front passenger seat or a rear seat other than the driver's seat 12. In this case, the camera as the imaging device (the imaging device) may be suitably installed in various vehicle body components such as an instrument panel positioned in an anterior portion of an automobile body, a pillar, a door, a windshield, and a seat, according to need. Though the aforementioned embodiment has been described with regard to the arrangement of the vehicle seat detecting system 100 to be installed in an automobile, the present invention can be adopted to object detecting systems to be installed in various vehicles other than automobile such as an airplane, a boat, a bus, a train, and the like.

The priority application, Japanese patent application no. 2006-170, filed Jun. 20, 2006 is incorporated herein by reference in its entirety.

Concerning the controllers and processors mentioned above, it should be understood that the various controllers and processors may be embodied in several distributed components or modules. For example, a single controller or processor may be comprised of several controllers and/or processors. In the alternative, the several controllers and processors may be embodied in a single functional module such as a master controller and/or processor.

The foregoing description of a preferred embodiment has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A vehicle seat detecting system, comprising:
an imaging device for detecting a three-dimensional surface profile of the vehicle seat from a single view point;
a controller including an image processor for digitizing the three-dimensional surface profile detected by the imaging device into a numerical coordinate system and a computational processor deriving information about a seat back shoulder region among respective regions of the vehicle seat based on the numerical coordinate system.

2. A vehicle seat detecting system as claimed in claim 1, further comprising a storage device for storing plural kinds of positional information of the seat back shoulder region, wherein the computational processor derives information, mostly matching the information detected by the imaging device, from the plural kinds of positional information previously stored in the storage device.

3. A vehicle seat detecting system as claimed in claim 1, wherein the computational processor is configured to scan a plurality of points in the numerical coordinate system corresponding to a portion of the seat along a vertical direction on the back side of a seat back side edge by scanning beams from the rear to the front of the vehicle and wherein the computational processor derives information about the seat back shoulder region based on the information about the plurality of points of the seat back side edge detected by the scanning.

4. A vehicle seat detecting system as claimed in claim 1, wherein the computational processor conducts a process for determining the positional condition of the vehicle seat based on the derived information about the seat back shoulder region.

5. An operation device controlling system comprising:
a vehicle seat detecting system as claimed in claim 4;
an operation device which is actuated based on the positional condition of the vehicle seat determined by the computational processor; and
an actuation controller for controlling the actuation of the operation device.

6. A vehicle comprising an engine/running system;
an electrical system;
an actuation controller for conducting the actuation control of the engine/running system and the electrical system; and
a vehicle seat detecting system as claimed in claim 4.

7. A vehicle seat detecting system, comprising:
an imaging device for detecting a three-dimensional surface profile of the vehicle seat from a single view point;
an image processor for digitizing the three-dimensional surface profile detected by the imaging device into a numerical coordinate system; and
a processor for conducting a process for deriving information about a seat back shoulder region among respective regions of the vehicle seat based on the numerical coordinate system of the three-dimensional surface profile digitized by the image processor.

8. A vehicle seat detecting system as claimed in claim 7, further comprising:
a storage device for storing plural kinds of positional information of the seat back shoulder region, wherein the processor derives information, mostly matching the information detected by the imaging device, as the information about the seat back shoulder region from the plural kinds of positional information previously stored in the storage device.

9. A vehicle seat detecting system as claimed in claim 7, wherein in the numerical coordinate system of the three-dimensional surface profile digitized by the image processor, the processor scans a plurality of points along a vertical direction on the back side of a seat back side edge by scanning beams from the rear to the front of the vehicle and derives information about the seat back shoulder region based on the information about the plurality of points of the seat back side edge detected by the scanning.

10. A vehicle seat detecting system as claimed in claims 7, wherein the processor conducts a process for determining the positional condition of the vehicle seat based on the derived information about the seat back shoulder region.

11. An operation device controlling system, comprising:
a vehicle seat detecting system as claimed in claim 10;
an operation device which is actuated based on the positional condition of the vehicle seat determined by the processor of the vehicle seat detecting system; and
an actuation controller for controlling the actuation of the operation device.

12. A vehicle, comprising:
an engine/running system;
an electrical system;
an actuation control device for conducting the actuation control of the engine/running system and the electrical system; and
a vehicle seat detection device for detecting positional condition of a vehicle seat, wherein the vehicle seat detection device comprises a vehicle seat detecting system as claimed in claim 10.

13. A seat detecting method, comprising the steps of:
detecting a three-dimensional surface profile of the vehicle seat from a single view point;
digitizing the detected three-dimensional surface profile into a numerical coordinate system;
deriving information about a seat back shoulder region among respective regions of the vehicle seat based on the numerical coordinate system; and
storing the information about the seat back shoulder region.

14. The seat detecting method of claim 13, further comprising the step of:
storing plural kinds of positional information of the seat back shoulder region, from which in combination with the detected three-dimensional surface profile, the information about the seat back shoulder region is derived.

15. The seat detecting method of claim 13, wherein the digitizing step further comprises:
scanning a plurality of points along a vertical direction on the back side of a seat back side edge by scanning beams from the rear to the front of the vehicle.

16. The seat detecting method of claim 15, wherein the deriving step further comprises:
deriving information about the seat back shoulder region based on the information about the plurality of points of the seat back side edge detected by the scanning.

17. The seat detecting method of claim 13, further comprising the step of determining the positional condition of the vehicle seat based on the derived information about the seat back shoulder region.
